(19) United States
(12) Patent Application Publication
(10) Pub. No.: US 2009/0278935 A1
(43) Pub. Date: Nov. 12, 2009

(54) Classroom monitor

(76) Inventor: Christopher D. Rainier, Calera, AL (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 12/149,695

(22) Filed: May 7, 2008

(51) Int. Cl. H04N 7/18

(52) U.S. Cl. 348/158; 348/E07.085

(57) ABSTRACT

A monitor for the remote observation of a child's behavior in a classroom. The classroom monitor includes a three-ring binder and a video camera that is releasably mounted upon the binder for producing a video signal. A microphone is affixed to the video camera for producing an audio signal. A central processing unit is connected to the video camera and the microphone for digitizing the video and audio signals. A digital memory is connected to the central processing unit for storing the video and audio signals digitized by the central processing unit. A USB port is connected to the digital memory for retrieving the video and audio signals stored in the memory.

### FIELD OF THE INVENTION

The present invention relates generally to apparatus for education and demonstration and, more particularly, to such apparatus having audio and video recording means.

### BACKGROUND OF THE INVENTION

Educators have long known that some children tend to perform better than others in a classroom setting. Gender, race, economic status, and the upbringing of a child all seem to have an effect. Children with attention-deficit hyperactivity disorders (ADHD), however, can have a particularly difficult time. The misbehavior of children diagnosed with ADHD often requires considerable amounts of a teacher's time to correct and distracts other children thereby reducing learning opportunities.

ADHD affects about five percent of all children. It is characterized by a persistent pattern of inattention, hyperactivity, forgetfulness, impulsivity, and distractibility. ADHD is currently considered to be a chronic condition for which there is no cure. Treatment methods involve a combination of medication, behaviour modification, life style changes, and counseling.

It is difficult for parents, doctors, and school personnel who desire to closely monitor the classroom behavior of a child with ADHD. When watched, such children temporarily change their behavior for the better. A need, therefore, exists for an unobtrusive product that permits designated adults to remotely observe the normal behavior of a child in a classroom.

### SUMMARY OF THE INVENTION

In light of the problems associated with the known methods of observing and tracking the classroom behavior of children, particularly those with ADHD, it is a principal object of the invention to provide a monitor that continuously captures the sights and sounds of a classroom throughout a school day. The monitor records audio interactions of a student with his teacher and peers and records video of and records video of an individual student and not a broad view of an entire classroom. For many children, knowing that a responsible adult can observe his behavior is sufficient to change the classroom behavior of the child for the better.

It is an additional object of the invention to provide a classroom monitor of the type described that serves as a behavior modification tool. It will cause the student to act and/or stay on task as they would if their parent or guardian were sitting in class observing. Misbehavior, when it does occur, can be dealt with daily and corrected from the home.

It is another object of the present invention to provide a classroom monitor of the type described that permits a child to catch-up on missed assignments in the event of an absence from the classroom. If a child is absent from class a parent or guardian may have the ability to borrow a school issued unit for the night to enable the student to view the missed lecture from home. A child need never be left behind.

It is a further object of the present invention to provide a classroom monitor that will hold teachers to a high level of accountability for events that take place in their classrooms. Teacher misbehavior, while rare, can be observed and subsequently punished.

It is an additional object of the invention to provide a classroom monitor that serves as a behavior modification tool, causing a student to act and/or stay on task as he would if his parent or guardian were observing the student from a nearby location in the classroom.

It is still a further object of the invention to provide a classroom monitor of the type described wherein the data recorded within it can only be accessed by a responsible adult and not a child.

It is an object of the invention to provide improved features and arrangements thereof in a classroom monitor for the purposes described which is lightweight in construction, inexpensive to manufacture, and dependable in use.

Briefly, the classroom monitor in accordance with this invention achieves the intended objects by featuring a three-ring binder and a video camera that is releasably mounted upon the binder for producing a video signal. A microphone is affixed to the video camera for producing an audio signal. A central processing unit is connected to the video camera and the microphone for digitizing the video and audio signals. A digital memory is connected to the central processing unit for storing the video and audio signals digitized by the central processing unit. A USB port is connected to the digital memory for retrieving the video and audio signals stored in the memory. One or more retaining clips can be utilized to fasten the monitor to a desktop when the monitor is detached from the three-ring binder.

The foregoing and other objects, features, and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a perspective view of a classroom monitor in accordance with the present invention shown mounted on a three-ring binder.

FIG. 2 is a side view of the classroom monitor and the three-ring binder of FIG. 1 with portions broken away to reveal mounting details.

FIG. 3 is an exploded perspective view of the classroom monitor and a portion of its associated binder.

FIG. 4 is a side view of the classroom monitor shown clipped to a desktop.

FIG. 5 is a perspective view of an inverted desktop monitor with its optional retaining clips positioned for insertion in retaining slots.

FIG. 6 is a schematic diagram of the electrical circuit of the classroom monitor.

Similar reference characters denote corresponding features consistently throughout the accompanying drawings.

### DETAILED DESCRIPTION OF THE PREFERRED EMBODIMENT

Referring now to the FIGS., a classroom monitor in accordance with the present invention is shown at 10. Monitor 10 includes a video camera 12 and a microphone 14 that are connected through a central processing unit (CPU) 16 to a digital memory 18 capable of capturing data streaming from camera 12 and microphone 14. Data stored in memory 18 can be retrieved through a USB port 20. Monitor 10 is releasably attached to a three-ring binder 22 for easy transport and storage.

Camera 12 includes a lens 24, an imager (not shown) and a recorder, i.e., CPU 16. Lens 24 gathers and focuses light on the imager. The imager, in turn, converts the incident light into an electronic video signal. Finally, CPU 16 encodes the video signal into a form that can be stored in memory 18 and delivers the signal to memory 18.

For the sake of simplicity of operation of monitor 10, the amount of light passing through lens 24, the field of view of lens 24 and the shutter speed of lens 24 are set at the time of manufacture. Alternatively, these optical characteristics could be automatically controlled by camera 12. The addition of additional electronic controllers to the camera 12 to enhance image quality is, of course, a matter of design choice and would add to the cost of monitor 10.

The imager is the “eye” of camera 12, housing a photosensor. Lens 24 projects an image onto the photosensor for a predetermined period. The light exposure is converted into an electrical charge which is registered at the imager's output terminals. Then, the photosensor is reset to start the exposure-process for the next video frame.

CPU 16 makes the analog-to-digital conversions so as to digitize the imager output into a discrete digital-video signal. CPU 16 writes the video signal onto memory 18 in a digital form. Although not shown for the sake of simplicity, CPU 16 is connected to push-button controls that allow a user to selectively energize camera 12. CPU 16 has a clock 26 that can be set by means of the push-button controls. The time at which video is recorded is automatically displayed atop the video images at the time of playback.

Microphone 14 is an acoustic-to-electric transducer that converts sound into an analog electrical signal that is delivered to CPU. In CPU 16, the analog audio signal is converted into a stream of numbers representing the changes in air pressure through time. CPU 16 conveys the digitized sound stream to memory 18 where such is recorded for playback at a later time.

Digital memory 18 is a hard disk drive (HDD) that stores digitally encoded data on rapidly rotating platters with magnetic surfaces. Capacity of a HDD for use in monitor 10 is several gigabytes though capacities measurable in terms of megabytes might be practical if monitor 10 is intended to be used for brief periods of time. Data stored on a HDD is accessible through USB port 20 to which it is connected.

Monitor 10 is provided with a compass 28. Compass 28 is preferably a solid-state device comprising two or three magnetic field sensors that provide data for a microprocessor. Using basic trigonometry, the correct heading relative to the compass is calculated. A display unit connected to the compass microprocessor permits a user to monitor his heading.

Monitor 10 houses a global positioning system (GPS) receiver 30. Receiver 30 includes: an antenna tuned to frequencies transmitted by satellites, a processor, and a clock. Receiver 30 also has a display for providing location and speed information to a user. A receiver is often described by its number of channels which signifies how many satellites it can monitor simultaneously. Originally limited to four, this number has progressively increased to include as many as twenty. Receiver 30 can transmit position data to memory 18 that can be subsequently retrieved by a user via USB port 20.

A rechargeable, lithium battery 32 powers monitor 10. Such batteries are suitable for low-drain, long-life application over a wide range of temperatures and are often used in cameras. Lithium batteries are commonly used in portable electronic devices, such as: personal digital assistants (PDAs), watches, thermometers, and calculators. In particular, lithium batteries can easily support the brief, heavy current demands of devices such as video cameras and they maintain a higher voltage for a longer period than alkaline cells.

A battery charger 34 is employed within monitor 10 to reenergize battery 32 when it becomes depleted by forcing an direct electrical current through it. The characteristics of the charging current depend upon the character of battery 32. Preferably, charger 34 monitors voltage, temperature and time under charge for battery 32 so as to determine the optimum charging current. Charging is ended when the monitored parameters indicate that battery 32 is fully charged. Typically, charger 34 will fast-charge battery 32 up to about 85% of its maximum capacity in less than an hour and, then, switch to trickle charging to top off battery 32 to full capacity over the next several hours.

A Universal Serial Bus (USB) port 20 is provided in the side of monitor 10. USB port 20 permits monitor 10 to be connected to a personal computer using a single, standardized interface socket. When connected, data stored in memory 18 can be accessed instantly without rebooting the computer and without requiring that a special driver be installed in the computer.

Three-ring binder 22 is a folder in which paper sheets 36 are held by means of a clamp 38. Binder 22 includes a narrow spine 40 to which a front cover 42 and a back cover 44 are hingedly attached to resemble a hardback book. Clamp 38 is attached to back cover 44 by means of penetrating fasteners or otherwise. Clamp 38 is provided with three, spaced-apart, split-rings 46. Internal springs normally hold rings 46 closed, however, release levers 48 provided at the opposite ends of clamp 38 permit rings 46 to be opened and their now free ends to be extended through correspondingly positioned holes in sheets 36.

Binder 22 can be made from any suitable material and can be provided in any size, though there are many standards with respect to both capacity and paper size. The most common size binder in the United States accepts “letter size” sheets measuring 11 inches (28 cm) by 8½ inches (22 cm). A standard 11×8½ in. sheet of paper has 3 holes with spacing of 4¼″ (11 cm). A rectangular aperture 50 for snugly receiving a tray 52 is provided in the center of front cover 42 remote from clamp 38.

Tray 52 includes a rectangular bottom wall 54 having a side wall 56 affixed to, and extending upwardly from, the periphery thereof. Side wall 56 is provided with a pair of fastening apertures 58 through which a pair of screws 60 is extended into receiving holes 62 in monitor 10 to retain monitor 10 within tray 52. Affixed to, and extending outwardly from, the periphery of side wall 56 is a mounting flange 64. Located at spaced-apart intervals around the perimeter of flange 64 are mounting apertures 66 for the passage of pop rivets 68 employed to fasten tray 52 to front cover 42 of binder 22. Receiving apertures 70 positioned around rectangular aperture 50 provide for the passage of rivets 68 through cover 42.

A pair of retaining slots 72 extends across the bottom of monitor 10. Each of slots 72 has a T-shaped cross section with a narrow stem portion 74 extending upwardly and opening into the center of a wide trunk portion 76. As shown, the configuration of slots 72 define a pair of opposed, retaining flanges 78.

Projecting downwardly from monitor 10 into each of trunk portions 76 is a pair of retaining pins 80. Each of pins 80 is about 1/32 inches (1 mm) tall and wide. Pins 80 are axially aligned with stem portion 74 and extend between flanges 78.

One of a pair of retaining clips 82 is fitted into a respective one of slots 72. Each of clips 82 is formed from a strip of spring steel into an elongated C-shape. Each clip 82 includes a base leg 84 adapted to slide snugly into one of trunk portions 76 and a retaining leg 86 that is held in opposition to base leg 84 by an intermediate leg 88 projecting downwardly from base leg 84. A pair of bores 90 is provided in each base leg 84 for snugly receiving retaining pins 80.

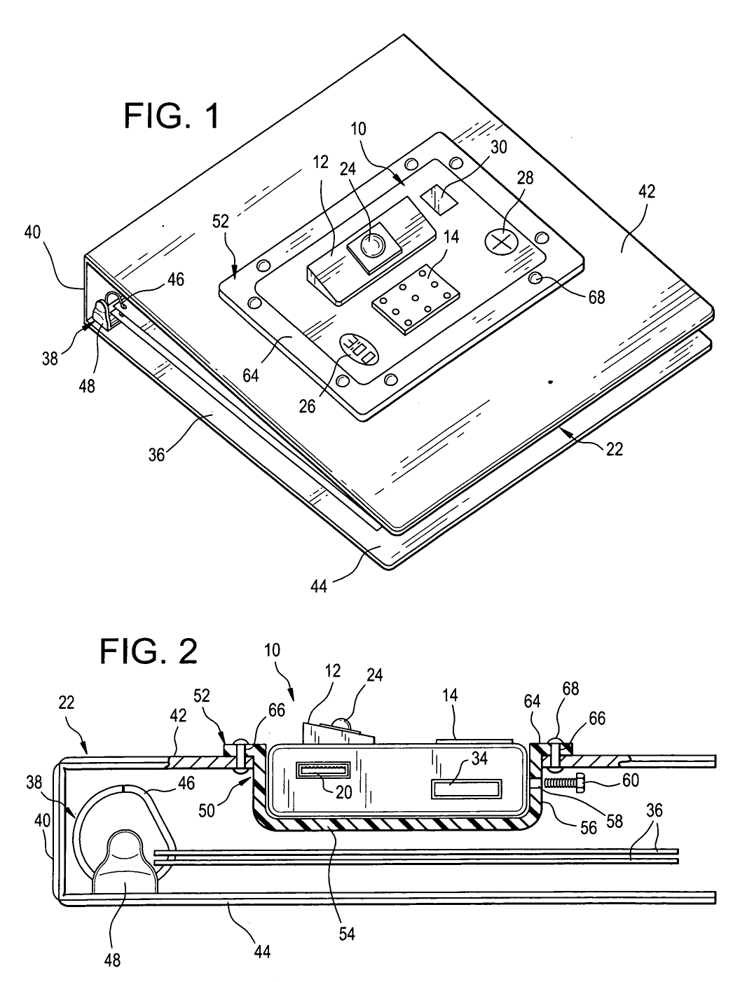

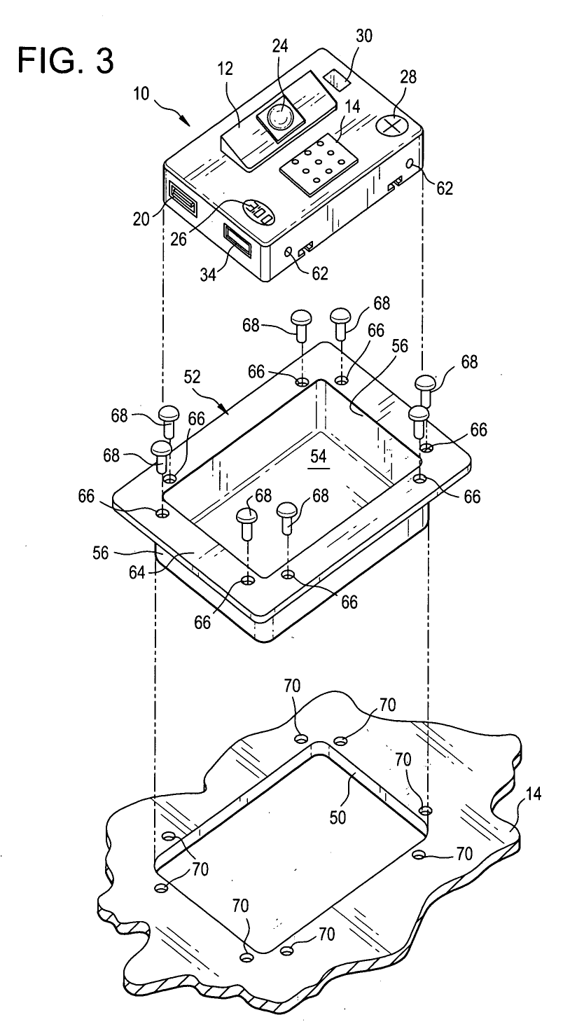

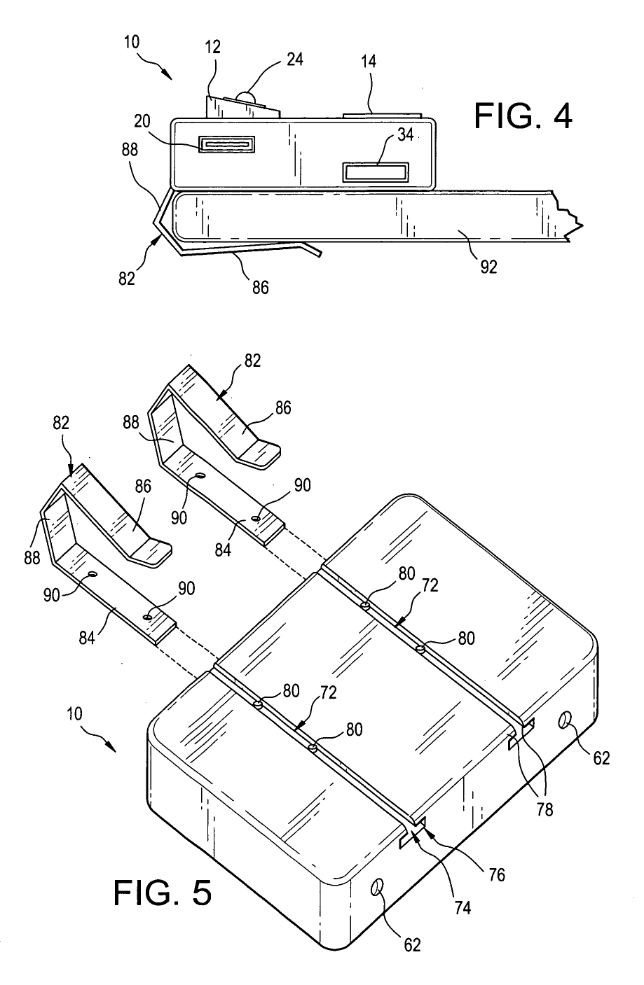

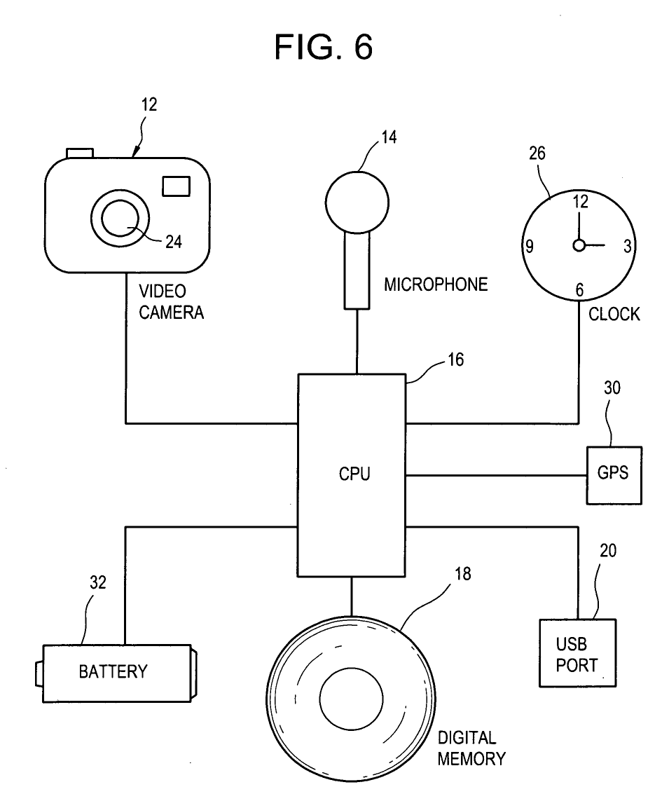

The use of monitor 10 is straightforward. First, assuming that monitor 10 is energized and mounted on binder 22 as illustrated in FIGS. 1 and 2, a user need only position binder 22 on a nearby horizontal supporting surface for monitor 10 to capture video and audio streams through camera 12 and microphone 14, respectively. Should the user ever decide to move to a new location, he need only transport binder 22 with him. Not only will the papers 36 of the user stay organized and close at hand in the confines of binder 22, but the ability to monitor classroom goings-on is never lost. Depending upon the capacity of memory 18 and battery 32, monitor 10 can stay energized for several hours or the entire school day.

Regardless of where monitor 10 is transported, a record of its location is always maintained in memory 18. GPS receiver 30 automatically calculates the latitude and longitude of monitor 10. If a child is interested in learning his coordinates on the planet, such can be gleaned by an examination of the display provided for this purpose on the front of monitor 10. Similarly, the correct time can be found by examining clock 26 on the front of monitor 10. Furthermore, a desired compass heading can be determined by reviewing compass 28.

When the child user brings binder 22 home at the end of the school day, his adult partner can access the data stored in memory 18. To do this, monitor 10 is removed from tray 52 by unscrewing screws 60 in the usual manner. Then, USB port 20 is connected to a personal computer with a compatible cord. By pressing appropriate keys on the keyboard of the personal computer, all stored data in memory 18 can be accessed by the adult and, if desired, copied to the memory of the personal computer. Video and audio can be played back in a coordinated fashion. Time data automatically superimposed on the video by CPU 16 makes it easy to fast-forward through several hours of video whose contents for a given day may be inconsequential. Behavior problems found in the reviewed data can be immediately addressed with the child.

Software will be included that will enable the parent or guardian to pre-program when the unit will turn on and off in accordance with the child's school schedule. Example: on for math, off for gym.

Once the data in memory 18 is viewed, it can be erased using keyboard commands from the personal computer. After recharging battery 32 by connecting it through charger 34 to a direct current source for a predetermined period of time, monitor 10 is repositioned in tray 52 and secured there by means of screws 60. Monitor 10 is now ready for immediate reuse.

If a child at school does not need binder 22, monitor 10 can be used with retaining clips 82 instead. Clips 82 are slid into slots 72 in the bottom of monitor 10 and held in place by the snap fit of pins 80 into bores 90. Now, retaining legs 86 of clips 82 are slid over an edge of desktop 92 where the child user will work in a classroom. With monitor 10 clipped to desktop 92, it will record video and audio data to memory 18 for as long as desired. When a child brings monitor 10 home, data recorded into memory 18 can be retrieved in substantially the same manner as when monitor 10 is mounted in tray 52 except that screws 60 need not be untightened.

The elevated position of lens 24 on monitor 10 ensures that a child user cannot hide throughout the school day regardless of whether monitor 10 is secured within tray 52 or used with clips 82. Though USB port 20 remains accessible when clips 82 are employed with monitor 10, the data in memory 18 remains inaccessible to a child user without access to a personal computer. If desired, standard encryption techniques or passwords can be preprogrammed into CPU 16 to limit data access to a finite number of people.

While classroom monitor 10 has been described with a high degree of particularity, it will be appreciated by those skilled in the art that modifications can be made to it. For example, a radio transceiver can be incorporated into monitor 10 for broadcasting to a remote receiver any data stored in memory 18 in addition to real-time video and audio streams. Data broadcasts can be initiated by means of instructions sent to the transceiver by a remote transmitter or can be automatically made at predetermined times. Therefore, it is to be understood that the present invention is not limited to classroom monitor 10 described above, but encompasses any and all monitors within the scope of the following claims.

I claim:

1. A classroom monitor, comprising:
a three-ring binder;
a video camera being releasably mounted upon said binder for producing a video signal;
a microphone being affixed to said video camera for producing an audio signal;
a central processing unit being connected to said video camera and said microphone for digitizing said video and audio signals;
a digital memory being connected to said central processing unit for storing said video and audio signals digitized by said central processing unit; and,
a USB port being connected to said digital memory for retrieving said video and audio signals stored in said memory.

2. The classroom monitor according to claim 1 wherein said three-ring binder further includes:
a spine;
a front cover being hingedly attached to said spine, said front cover having an aperture therein;
a back cover being hingedly attached to said spine opposite said front cover;
a tray being affixed within said aperture in said front cover, said tray having a recess therein for snugly receiving said video camera; and,
a plurality of threaded fasteners penetrating said tray for securing said video camera within said recess.

3. The classroom monitor according to claim 1 further comprising at least one retaining clip being affixed to said camera for releasably fastening said monitor to a desktop.

4. The classroom monitor according to claim 1 further comprising a GPS receiver being connected to said central processing unit for determining the position of said monitor.

5. The classroom monitor according to claim 1 further comprising a compass being affixed to said video camera for determining a heading from said monitor.

6. The classroom monitor according to claim 1 further comprising a clock being connected to said central processing unit for keeping time and for programming on and off time.
